(19) United States
(12) Patent Application Publication
(10) Pub. No.: US 2009/0072739 A1
(43) Pub. Date: Mar. 19, 2009

(54) Plasma display panel and method of forming electrode thereof

(76) Inventors: Young-Hwa Song, Suwon-si (KR); Chang-Seok Rho, Suwon-si (KR); Seung-Heon Oh, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/230,804

(22) Filed: Sep. 4, 2008

(30) Foreign Application Priority Data
Sep. 6, 2007 (KR) 10-2007-0090458

(51) Int. Cl. H01J 17/49; H01J 9/12

(52) U.S. Cl. 313/585; 445/51

(57) ABSTRACT

A method of forming an electrode of a plasma display panel capable is developed in order to prevent short circuit between electrodes, and a plasma display panel manufactured according to the method.

The plasma display panel includes an upper substrate and a lower substrate disposed to face each other; address electrodes formed on the lower substrate; a barrier rib disposed in a space between the upper substrate and the lower substrate to form a plurality of discharge cells; a phosphor layer formed inside each of the discharge cells; and sustain electrodes and scan electrodes formed on the upper substrate so that they are crossed with the address electrodes, wherein ends of neighboring address electrodes have a longitudinal positional difference.

### CLAIM FOR PRIORITY

This application makes reference to, incorporates the same herein, and claims all benefits accruing under 35 U.S.C. §119 from an application for PLASMA DISPLAY PANEL AND ELECTRODE FORMING METHOD OF IT earlier filed in the Korean Intellectual Property Office on the 6^{th} of September 2007 and there duly assigned Ser. No. 10-2007-0090458.

### BACKGROUND OF THE INVENTION

1. Field of the Invention

The present invention relates to a plasma display panel, and more particularly, to a method of forming an electrode of a plasma display panel capable of preventing short circuit between electrodes, and a plasma display panel manufactured in accordance with this method.

2. Description of Related Art

Plasma display panel (PDP) is an electron apparatus that displays an image using plasma discharge. In other words, the plasma display panel displays an image by applying a predetermined voltage to electrodes disposed in a discharge space of the plasma display panel to cause a plasma discharge between the electrodes and exciting a phosphor layer formed with a predetermined pattern by the ultraviolet rays generated during the plasma discharge.

A plurality of row electrodes and a plurality of column electrodes are formed in the plasma display panel of the plasma display apparatus, and discharge cells are formed in the positions where row electrodes and column electrodes are crossed with each other. And, the plasma display panel represents grey levels of the image by controlling a discharging state of the discharge cells.

Distances of the row electrodes and/or the column electrodes, however, become narrower due to the recent tendency to enhance the resolution of the plasma display panel, and therefore there occurs an increasing risk of short circuit between electrodes due to the erroneous operation in the manufacturing process of the plasma display panel.

In particular, when the row electrodes and/or the column electrodes of the plasma display panel are formed by using an offset printing process, i.e., a method of forming an electrode having an excellent quality with a low manufacturing cost, the offset printing process has a very high possibility that short circuit occurs between neighboring electrodes due to an expansion of the volume of material that forms the electrodes in end points during a transfer process.

### SUMMARY OF THE INVENTION

It is therefore an object of the present invention to provide an improved plasma display panel to overcome the short circuit occurring between the neighboring electrodes.

It is another object of the present invention to provide a method of forming , electrodes capable of preventing the short circuit between the neighboring electrodes of the plasma display panel, and the plasma display panel formed according to this method.

It is still another object of the present invention to provide a method of forming an electrode capable of preventing the short circuit between electrodes caused by an expansion of the volume of an electrode-forming material in end points of the plasma display panel, and a plasma display panel manufactured according to the method.

The first aspect of the present invention is achieved by providing a plasma display panel including an upper substrate and a lower substrate disposed to face each other; address electrodes formed on the lower substrate; a barrier rib for compartmentalizing a plurality of discharge cells disposed in a space between the upper substrate and the lower substrate to form a display region; a phosphor layer formed inside each of the discharge cells; and sustain electrodes and scan electrodes formed on the upper substrate so that they are crossed with the address electrodes, wherein end points of the neighboring address electrodes have a longitudinal positional difference.

Also, the plasma display panel constructed as the present invention may further include address drivers coupled to the other ends of the address electrodes.

Preferably, the address electrodes may include even-numbered address electrodes and odd-numbered address electrodes where ends of the odd-numbered address electrodes have the longitudinal positional difference compared to the ends of the even-numbered address electrodes, and be formed using an offset printing process.

The second aspect of the present invention is achieved by providing a plasma display panel including an upper substrate and a lower substrate disposed to face each other; address electrodes formed on the lower substrate; a barrier rib for compartmentalizing a plurality of discharge cells disposed in a space between the upper substrate and the lower substrate to form a display region; a phosphor layer formed inside of each of the discharge cells; and sustain electrodes and scan electrodes formed on the upper substrate so that they are crossed with the address electrodes and disposed to alternate a pair of scan electrodes and a pair of sustain electrodes, wherein ends of either the pair of the scan electrodes or the pair of the sustain electrodes have a longitudinal positional difference.

Also, the plasma display panel constructed as the present invention may further include scan drivers coupled to the other ends of the scan electrodes; and sustain drivers coupled to the other ends of the sustain electrodes.

Preferably, the scan electrodes and the sustain electrodes may be formed using an offset printing process.

The third aspect of the present invention is achieved by providing a method of forming an electrode of a plasma display panel including steps of forming concave grooves, which are flat in one direction, in a gravure; filling the concave grooves with an electrode-forming paste; transiting the paste from the concave grooves to a print blanket; and transferring the paste from the print blanket onto a substrate of the plasma display panel, wherein ends of the neighboring concave grooves on the gravure have a longitudinal positional difference.

Here, the gravure may be a plate gravure or, a roller-type gravure.

The electrodes may be address electrodes of the plasma display panel. In this case, the substrate becomes a lower substrate of the plasma display panel, and the address electrodes may preferably be metallic materials.

Also, the electrodes may be scan electrodes and sustain electrodes of the plasma display panel, or metallic bus electrodes included in the scan electrodes and sustain electrodes of the plasma display panel. In this case, the substrate becomes an upper substrate of the plasma display panel, and the plasma display panel may preferably have an electrode array disposed to alternate a pair of scan electrodes and a pair of sustain electrodes.

### BRIEF DESCRIPTION OF THE DRAWINGS

These and/or other embodiments and features of the present invention will become apparent and more readily appreciated from the following description of certain exemplary embodiments, taken in conjunction with the accompanying drawings of which:

FIG. 1 is a perspective view showing one exemplary embodiment of a plasma display panel that is applicable to one aspect of the present invention;

FIG. 2 is a partial top view showing a configuration of an address electrode of a plasma display panel constructed as one exemplary embodiment of the present invention;

FIG. 3 is a partial top view showing a configuration of scan and sustain electrodes of a plasma display panel constructed as another exemplary embodiment of the present invention;

FIGS. 4A through 4C are conceptual diagrams showing the comparison of positional difference between end points of electrodes in a longitudinal direction according to one aspect of the present invention with that of the contemporary electrodes, and the preferable positional difference range;

FIG. 5A is a cross-sectional view showing one exemplary embodiment of an apparatus of forming an electrode of a plasma display panel that is applicable to still another aspect of the present invention; and

FIG. 5B is a cross-sectional view showing another exemplary embodiment of an apparatus of forming an electrode of a plasma display panel that is applicable to still another aspect of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “coupled to” another element, it can be directly connected to the another element or be indirectly connected to the another element with one or more intervening elements interposed therebetween. Hereinafter, like reference numerals refer to like elements.

For one exemplary embodiment of the plasma display panel, a plurality of discharge cells arranged in a matrix type are interposed between upper and lower substrates having scan electrodes and sustain electrodes causing mutual discharge and a plurality of address electrodes, all of which are disposed in the upper and lower substrates, and the facing upper and lower substrates are then attached to each other. A predetermined amount of discharge gas is injected between both substrates, and a predetermined discharge pulse is then applied between discharge electrodes to excite a phosphor applied inside the discharge cells. Then the excited phosphor is allowed to emit the visible light, and the plasma display panel uses the generated visible light to display a predetermined image.

The electrodes of a plasma display panel may be easily formed at a low manufacturing cost by transferring an electrode-forming material to a substrate using an offset printing process. At this time, an expansion of the volume of material that forms the electrode occurs in one end of the heated electrode-forming material. The end of the heated electrode-forming material has a wider width than the other region. If the expansion phenomenon occurs in two adjacent positions, there is an increasing risk of the short circuit between the corresponding electrodes.

In the present invention, in order to space apart ends of two electrodes when the expansion phenomenon occurs in two adjacent positions, there is proposed a configuration where ends of electrodes in the same group that are present in the same position in the art have a positional difference in length compared to ends of neighboring electrodes. A variety of configurations may be used as the configuration, but a configuration where ends of the electrodes having the positional difference in length are disposed in a zig-zag manner, is preferred to reduce a wasted area of the substrate.

### EMBODIMENTS

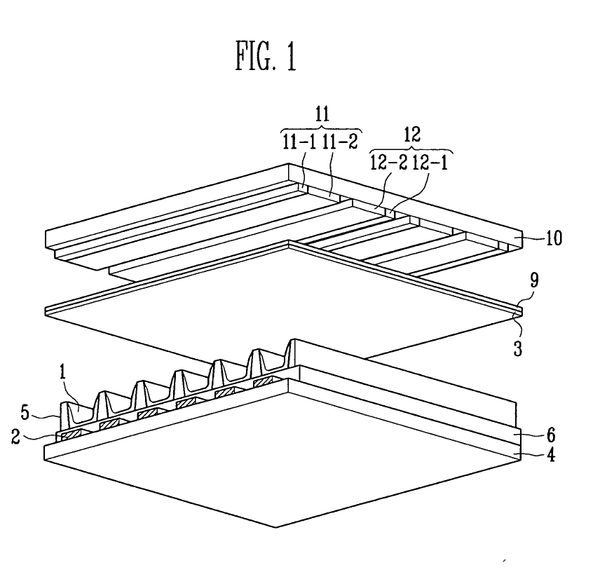

The plasma display panel may be divided into an AC type, a DC type and a hybrid type, depending on their configuration. FIG. 1 shows an AC type plasma display panel. As shown in FIG. 1, the plasma display panel includes a lower substrate 4; address electrodes 2 formed on lower substrate 4; a dielectric layer 6 formed on lower substrate 4 having address electrode 2 formed therein; a barrier rib 5 formed on dielectric layer 6 to maintain a discharge distance and prevent cross talks between cells; and a phosphor layer 1 formed on a surface of barrier rib 5.

Furthermore, the plasma display panel includes scan electrodes 11 and sustain electrodes 12 formed in upper substrate 10. Scan electrodes 11 and sustain electrodes 12 are disposed perpendicular to address electrodes 2, and one discharge cell therefore corresponds to a pair of the crossed electrodes. A dielectric layer 9 and a passivation layer 3 are formed in order to cover scan electrodes 11 and sustain electrodes 12.

Scan electrode 11 and sustain electrode 12 are disposed spaced apart at a predetermined distance along one direction of upper substrate 10. In this case, each of scan electrodes 11 and/or sustain electrodes 12 may be formed with combinations of transparent electrodes 11-2, 12-2 and metallic bus electrodes 11-1, 12-1 as shown in FIG. 1, transparent electrodes 11-2, 12-2 being formed of transparent materials such ITO, and metallic bus electrodes 11-1, 12-1 being respectively electrically coupled to transparent electrodes 11-2, 12-2. This dual electrode structure has advantages that the entire electrode resistance may be lowered by forming bus electrodes 11-1, 12-1 using high conductive materials, such as Ag, as a raw material since it is difficult for transparent electrodes 11-2, 12-2 to transmit an electric current because transparent electrodes 11-2, 12-2 for transmitting discharge light in the discharge cells is thin and has a high resistance.

A dielectric layer 9 and an MgO passivation layer 3 are laminated on upper substrate 10 while covering scan electrodes 11 and sustain electrodes 12.

Also, address electrodes 2 are formed on lower substrate 4 coupled to upper substrate 10, address electrodes 2 being crossed at a right angle with scan electrodes 11 and sustain electrodes 12, and a dielectric layer 6 is formed on lower substrate 4 while covering address electrodes 2.

In addition, a barrier rib 5 that compartmentalize a plurality of discharge spaces is formed between upper substrate 10 and lower substrate 4, and phosphor layers 1 is formed on side walls of barrier rib 5 disposed inside the discharge space, and also formed on dielectric layer 6, with the phosphor layers being composed of R, G and B phosphors.

The plasma display panel may be manufactured as one display device by applying frit as an adhesive means around upper substrate 10 and lower substrate 4 while each of the above-mentioned components is formed on either upper substrate 10 or lower substrate 4, followed by undergoing sealing and exhaust processes, etc.

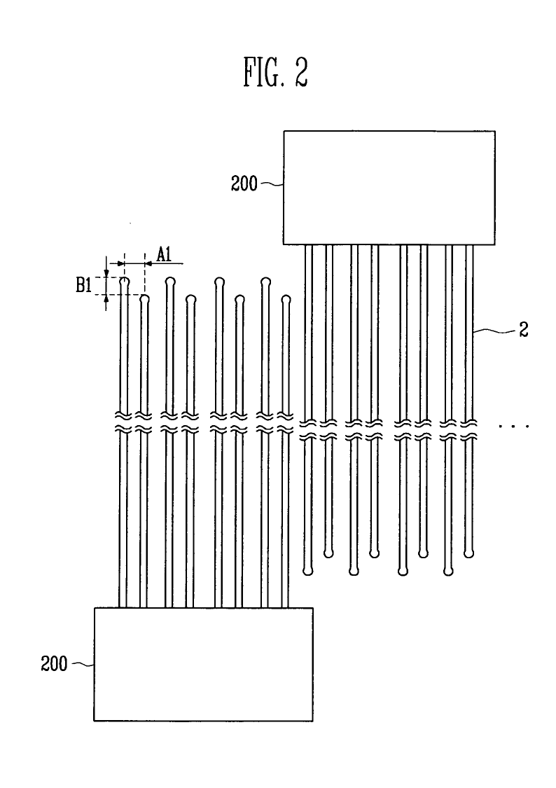

FIG. 2 shows a configuration of an address electrode of the plasma display panel constructed as one exemplary embodiment of the present invention. As shown in FIG. 2, address electrodes 2 are grouped into a predetermined number of address electrodes and the ends of each group of address electrodes are coupled to one address driver 200. In this case, address drivers 200 may be alternately disposed in two opposite portions of a plasma display panel, i.e., an upper portion and a lower portion of a chassis base on which a plasma display panel is attached.

This is merely to enhance drive uniformity of the address drivers and facilitate the disposition of the address drivers if it has a high resolution, but it is understood that the aspects of the present invention are applicable thereto if the address drivers are disposed only in either an upper portion or a lower portion of the panel.

An end point where an electrode comes to an end on the substrate is formed in one end of each of the address electrodes, and the other end of each of the address electrodes is coupled to address driver 200.

Among the address electrodes coupled to one address driver 200 according to this exemplary embodiment, ends of even-numbered electrodes and ends of odd-numbered electrodes have a longitudinal positional difference. The longitudinal positional difference is maintained in a longitudinal direction of the electrodes at a predetermined distance.

Therefore, although the address electrodes are manufactured using an offset printing process, it is possible to effectively prevent the short circuit caused by the solution lumping in the end points during the offset printing process.

The longitudinal positional difference of two neighboring electrodes in the end point of each of the address electrode pairs is preferably similar to the distance between two neighboring address electrodes. In other words, distance A1 may be similar to distance B1 as shown in FIG. 2.

In order to apply to a HD (high definition) high-resolution plasma display panel in which a distance between two neighboring address electrodes is in a range of from approximately 60 μm to approximately 90 μm, it is desirable to set a longitudinal positional difference of two neighboring electrodes in the end point of each of the address electrode pairs to approximately 20 μm to approximately 100 μm. This is because that the risk of the short circuit by the solution lumping is increased when the longitudinal positional difference in each of the address electrodes of the HD plasma display panel is less than 20 μm, while an effect of preventing the solution lumping may not be further improved if the longitudinal positional difference exceeds 100 μm.

A preferable value of the longitudinal positional difference will be calculated, as follows.

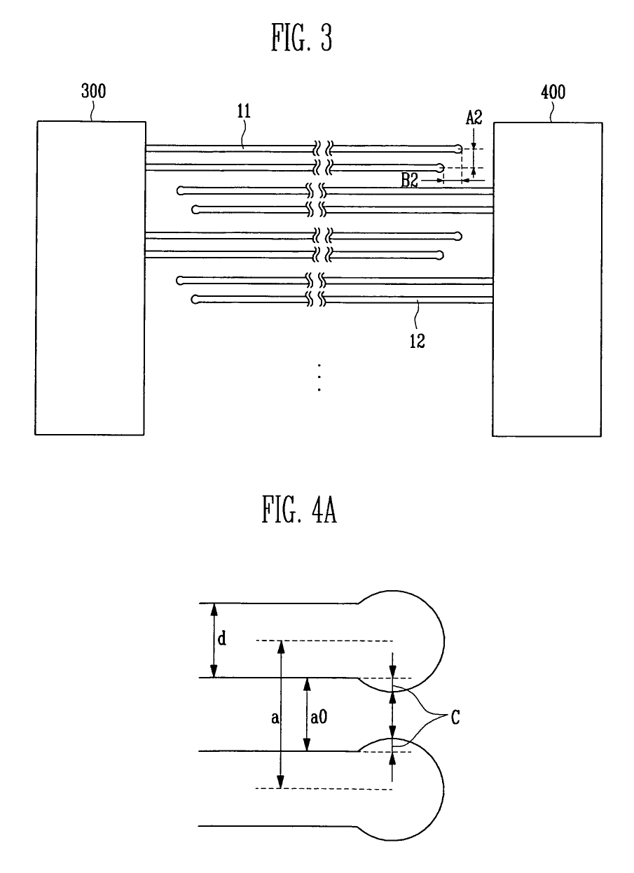

FIG. 3 shows a configuration of scan/sustain electrodes of the 3-electrode surface discharge plasma display panel according to one exemplary embodiment of the present invention. A scan electrode pair and a sustain electrode pair have an alternating XXYY-type electrode array, a scan driver 300 electrically coupled to the scan electrodes to drive scan electrodes 11 is disposed in one side of the panel, and a sustain driver 400 coupled to sustain electrodes 12 to drive the sustain electrodes is disposed in an opposite side of the panel. That is to say, an end point where an electrode comes to an end on the substrate is formed in one end of each of the scan electrodes and the sustain electrodes, and the other ends of each of scan electrodes 11 and sustain electrodes 12 is respectively electrically coupled to scan drivers 300 and sustain driver 400.

Each of the scan electrodes and sustain electrodes as shown in FIG. 3 may be formed in a dual structure of the transparent electrode and the bus electrode as shown in FIG. 1. In this case, the transparent electrode has almost no possibility of the short circuit by the volume expansion phenomenon in the manufacturing process, but the bus electrode has a high possibility of the short circuit in the manufacturing process. Therefore, each of the bus electrode pairs is disposed toward the barrier rib as close as possible, since materials of the bus electrode are opaque, which leads to the more increased risk of the short circuit in the case of the high-definition panel.

In the case of the bus electrodes forming each of pairs according to this exemplary embodiment as shown in FIG. 3, end points of the bus electrodes are formed at different positions in a longitudinal direction of the electrodes. Therefore, although the bus electrodes are formed using an offset printing process, the short circuit induced by the solution lumping in the end points may be effectively prevented during the manufacturing process. The positional difference in a longitudinal direction of the electrodes in the end points of each of the bus electrode pairs is preferably similar to the distance between electrodes forming pairs. In other words, distance A2 may be similar to distance B2 as shown in FIG. 3.

In order to apply to the current HD high-resolution plasma display panel where the distance between neighboring bus electrodes forming pairs is approximately 60 μm and the distance between neighboring different bus electrode pairs is approximately 90 μm, it is desirable to set a positional difference in a longitudinal direction of the electrode in the end points of each of the bus electrode pairs to a range of from approximately 20 μm to approximately 100 μm. The risk of the short by the solution lumping may be increased when the longitudinal positional difference in each of the bus electrodes of the HD plasma display panel is less than 20 μm, while an effect of preventing the solution lumping may not be further improved when the longitudinal positional difference exceeds 100 μm.

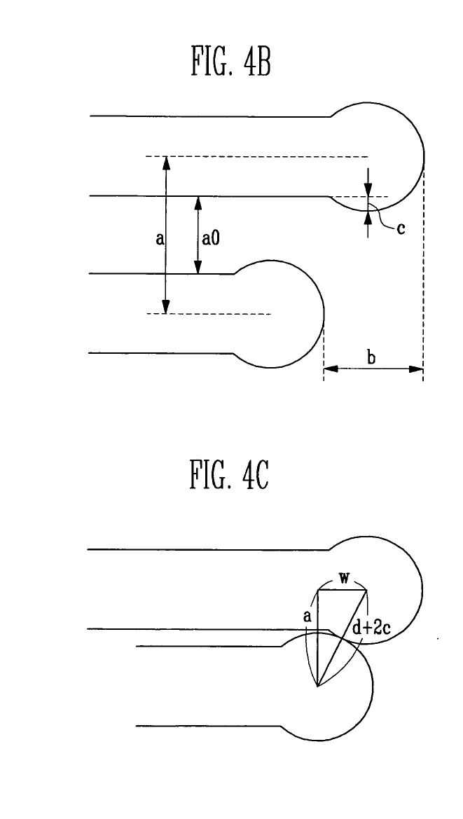

Advantages in a configuration of end points of the electrode of the plasma display panel constructed as this exemplary embodiment will be described with reference to FIGS. 4A and 4B, compared to the contemporary plasma display panel, and a preferable longitudinal positional difference in one end having end points of the electrodes formed therein will be described in details with reference to FIG. 4C.

As shown in FIG. 4A, the volume expansion phenomenon occurs in the end point of the electrode, and therefore the end point of the electrode is finished with a round shape that are wider than the initial width (d) of the electrode. In the case of the prior art as shown in FIG. 4A, if an end point diffusion width (c) is increased more than half of a spacing distance (a0) between the electrodes by the volume expansion phenomenon, the short circuit between the electrodes may be generated. In the case of the exemplary embodiment of the present invention as shown in FIG. 4B, however, it might be seen that the short circuit between the electrodes may be prevented until an end point diffusion width (c) becomes a spacing distance (a0) between the electrodes by the volume expansion phenomenon. Distance (a) refers to a distance between central axises of two neighboring electrodes.

As shown in FIG. 4C, the longitudinal positional difference (w) between end points of two electrodes is sufficient if the longitudinal positional difference (w) satisfies the following Inequality (1):

w>{(d+2c)²−a²}^{1/2} (1)

where w is longitudinal positional difference, a is a distance between central axises of two neighboring electrodes, c is a diffusion width by the volume expansion phenomenon, and d is an initial width of electrode.

Hereinafter, the offset printing process for forming electrodes will be described in details.

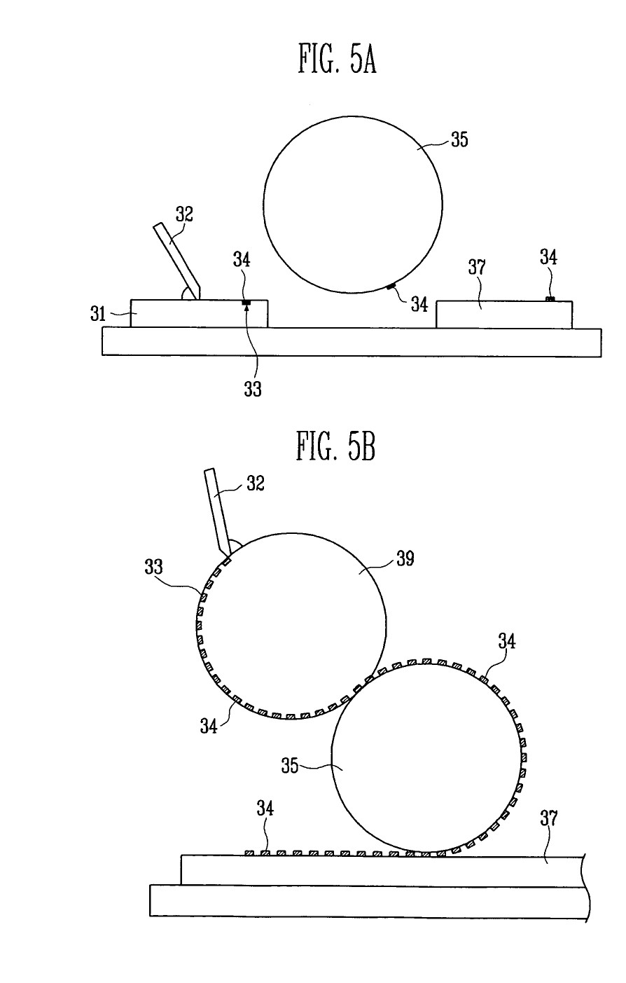

FIG. 5A is a cross-sectional view showing one exemplary embodiment of an apparatus of forming an electrode of a plasma display panel constructed to one aspect of the present invention, and FIG. 5B is a cross-sectional view showing another exemplary embodiment of an apparatus of forming an electrode of a plasma display panel that is applicable to one aspect of the present invention.

As shown in FIGS. 5A and 5B, for the process of forming electrodes on the substrate, scan/sustain electrodes and address electrodes are formed on upper or lower substrates by employing the following offset printing process. The scan/sustain electrodes has a dual electrode structure of transparent electrodes and bus electrodes, the offset printing process is applicable to the bus electrodes.

For the apparatus of forming electrodes as shown in FIG. 4B, the method of forming electrodes is carried out, including steps of forming concave grooves, which are flat in one direction, in a gravure; filling the concave grooves with an electrode-forming paste; transiting the paste from the concave grooves to a print blanket; and transferring the paste from the print blanket onto a substrate of the plasma display panel.

In order to form electrodes according to this exemplary embodiment, first, a gravure having concave grooves for forming an electrode should be prepared. One end, in which end points is formed, of each of the concave grooves formed on the gravure may be realized to have a predetermined longitudinal positional difference from ends of neighboring concave grooves, depending on the aspects of the present invention.

And, the concave grooves on gravure plate 31 are filled with an electrode-forming paste 34, and overflown paste 34 is removed using a blade 32.

Next, paste 34 filled in the concave groove 33 of gravure plate 31 is transited to a print blanket 35. Transited paste 34 is transferred to a glass substrate 37 constituting a panel. Then, glass substrate 37 is dried and sintered to complete the electrode-forming process.

Here, FIG. 5A is a conceptual diagram schematically showing steps of forming a concave groove 33 in a gravure plate 31, filling concave groove 33 with paste and transferring the pasted into a glass substrate, and FIG. 5B is a conceptual diagram schematically showing steps of forming a concave groove in a gravure roller 39, filling concave groove 33 with paste and transferring the paste onto printed blanket 35 then onto glass substrate 37.

That is to say, the concave groove according to this exemplary embodiment is formed in a gravure plate 31 or a gravure roll 35, and then filled with paste, and the paste is transited to blanket 35, and then transferred to glass substrate 37, with glass substrate 37 being an upper substrate or a lower substrate.

The method of forming an electrode of a plasma display panel according to the present invention, as described above, may be useful to prevent the short of the electrode during the process. In particular, the method according to the present invention may be useful to prevent the short of the electrode in the process that is widely used for forming an electrode of the plasma display panel.

Although exemplary embodiments of the present invention have been shown and described, it would be appreciated by those skilled in the art that changes might be made in these embodiments without departing from the principles and spirit of the invention, the scope of which is defined in the claims and their equivalents.

What is claimed is:

1. A plasma display panel, comprising:
an upper substrate and a lower substrate disposed to face each other and spaced apart from each other;
a plurality of address electrodes formed on the lower substrate;
a barrier rib disposed in a space between the upper substrate and the lower substrate to form a plurality of discharge cells;
a phosphor layer formed inside each of the discharge cells; and
a plurality of sustain electrodes and a plurality of scan electrodes formed on the upper substrate, and the plurality of sustaining electrodes and the plurality of scan electrodes being crossed with the address electrodes, with end points of neighboring address electrodes having a longitudinal positional difference.

2. The plasma display panel according to claim 1, in which the plurality of address electrodes include even-numbered address electrodes and odd-numbered address electrodes where ends of the odd-numbered address electrodes have the longitudinal positional difference from ends of the even-numbered address electrodes.

3. The plasma display panel according to claim 1, with the longitudinal positional difference between the end points of the neighboring address electrodes being greater than 20 μm.

4. The plasma display panel according to claim 1, in which the longitudinal positional difference satisfies:
w>{(d+2c)−a²}^{1/2},
where w is the longitudinal positional difference, a is a distance between central axises of neighboring address electrodes, c is a diffusion width of the address electrode due to a volume expansion of material forming the plurality of address electrodes, and d is an initial width of corresponding address electrodes.

5. The plasma display panel according to claim 1, in which the plurality of address electrodes are formed by using an offset printing process.

6. The plasma display panel according to claim 1, further comprising address drivers electrically coupled to ends of the plurality of address electrodes, with the ends of the plurality of address electrodes coupled to the address drivers being different from the ends of the plurality of address electrodes having the longitudinal positional difference.

7. A plasma display panel, comprising:
an upper substrate and a lower substrate disposed to face and spaced apart from each other each other;
a plurality of address electrodes formed on the lower substrate;
a barrier rib for compartmentalizing a plurality of discharge cells disposed in a space between the upper substrate and the lower substrate;
a phosphor layer formed inside each of the discharge cells; and
a plurality of sustain electrodes and a plurality of scan electrodes formed on the upper substrate with the plurality of sustain electrodes and the plurality of scan electrode being crossed with the address electrodes, a pair of the scan electrodes and a pair of the sustain electrodes being alternately disposed on the upper substrate, and ends of either the pair of the scan electrodes or the pair of the sustain electrodes having a longitudinal positional difference.

8. The plasma display panel according to claim 7, in which the longitudinal positional difference of either the ends of the pair of the scan electrodes or the ends of the pair of the sustain electrodes is greater than 20 μm.

9. The plasma display panel according to claim 7, in which the longitudinal positional difference satisfies:
w>{(d+2c)²−a²}^{1/2}
where w is the longitudinal positional difference, a is a distance between central axises of neighboring electrodes, c is a diffusion width due to a volume expansion of material forming the plurality of scan electrodes and the plurality of sustain electrodes, and d is an initial width of the corresponding scan electrodes and sustain electrodes.

10. The plasma display panel according to claim 7, in which the address electrodes are formed using an offset printing process.

11. The plasma display panel according to claim 7, further comprising:
scan drivers being electrically coupled to ends of the plurality of scan electrodes with the ends of the scan electrodes being different from the ends having the longitudinal positional difference; and
sustain drivers being electrically coupled to ends of the plurality of sustain electrodes with the ends of the sustain electrodes being different from the ends having the longitudinal positional difference.

12. The plasma display panel according to claim 7, in which the address electrodes include even-numbered address electrodes and odd-numbered address electrodes where ends of the odd-numbered address electrodes have the longitudinal positional difference from ends of the even-numbered address electrodes.

13. A method of forming electrodes of a plasma display panel, the method comprising:
forming concave grooves as molds for forming the electrodes of the plasma display panel, in which a first group of ends of the concave grooves are equal in length, in a gravure;
filling the concave grooves with an electrode-forming paste;
transiting the electrode-forming paste from the concave grooves to a print blanket; and
transiting the electrode-forming paste from the print blanket onto a substrate of the plasma display panel,
wherein a second group of ends of the neighboring concave grooves on the gravure have a longitudinal positional difference.

14. The method of claim 13, with the electrodes being address electrodes of the plasma display panel.

15. The method of claim 13, with the electrodes being scan electrodes and sustain electrodes of the plasma display panel.

16. The method of claim 15, with the plasma display panel having an electrode array formed by pairs of scan electrodes and pairs of sustain electrodes alternately disposed.

17. The method of claim 13, with the longitudinal positional difference being greater than 20 μm.

18. The method of claim 13, with the longitudinal positional difference satisfying:
w>{(d+2c)²−a²})^{1/2},
where w is longitudinal positional difference, a is a distance between central axises of two neighboring electrodes, c is a diffusion width of the electrodes due to a volume expansion of material forming the electrodes, and d is an initial width of the electrodes.

19. A plasma display panel, comprising:
a first substrate and a second substrate disposed to face each other and spaced apart from each other;
address electrodes formed on one selected from the first substrate and the second substrate, end points of neighboring address electrodes having a first longitudinal positional difference in a view along a direction where the address electrodes are extended, and the first longitudinal positional difference satisfying:
w>{(d+2c)²−a²})^{1/2},
where w is the first longitudinal positional difference, a is a distance between central axises of neighboring address electrodes, c is a diffusion width of the address electrode due to a volume expansion of material forming the address electrodes, and d is an initial width of the address electrodes;
a barrier rib forming a plurality of discharge cells disposed in a space between the first substrate and the second substrate;
a phosphor layer formed within each of the discharge cells; and
sustain electrodes and scan electrodes formed on one selected from the first substrate and the second substrate with the selected substrate being different from the substrate where the address electrodes being formed, and the sustaining electrodes and the scan electrodes being crossed with the address electrodes.

20. The plasma display panel of claim 19, with pairs of the scan electrodes and pairs of the sustain electrodes being alternately disposed on one selected from the first substrate and the second substrate with the selected substrate being different from the substrate where the address electrodes being formed, ends of either the pair of the scan electrodes or the pair of the sustain electrodes having a second longitudinal positional difference respectively in a view along directions where either the pair of the scan electrodes or the pair of the sustain electrodes are extended, and the second longitudinal positional difference satisfying:
w>{(d+2c)²−a²})^{1/2},
where w is the second longitudinal positional difference, a is the distance between central axises of neighboring scan electrodes or neighboring the sustain electrodes, c is the diffusion width of the scan electrode or the sustain electrode due to a volume expansion of material forming the scan electrodes and the sustain electrodes, and d is the initial width of the scan electrodes or the sustain electrodes.
